(19) United States
(12) Patent Application Publication
(10) Pub. No.: US 2006/0104354 A1
(43) Pub. Date: May 18, 2006

(54) Multi-layered intra-prediction method and video coding method and apparatus using the same

(75) Inventors: Woo-jin Han, Suwon-si (KR); Sang-chang Cha, Hwaseong-si (KR); Ho-jin Ha, Seoul (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 11/271,984

(22) Filed: Nov. 14, 2005

Related U.S. Application Data
(60) Provisional application No. 60/626,877, filed on Nov. 12, 2004.

(30) Foreign Application Priority Data
Jan. 6, 2005 (KR) 10-2005-0001299

(51) Int. Cl. H04N 11/04; H04N 7/12; H04B 1/66; H04N 11/02

(52) U.S. Cl. 375/240.03; 375/240.24; 375/240.12; 375/240.18

(57) ABSTRACT

A video coding method using a multi-layer structure, and more particularly, a method and apparatus for facilitating a search for an intra-prediction mode in an upper layer using an intra-prediction mode in a lower layer while efficiently and compressively encoding the searched intra-prediction mode are provided. The intra-prediction method includes searching for an optimum prediction mode of a current block among a predetermined number of intra-prediction modes, and obtaining a directional difference between the searched optimum prediction mode and an optimum prediction mode of a lower layer block corresponding to the current block.

### CROSS-REFERENCE TO RELATED APPLICATIONS

This application claims priority from Korean Patent Application No. 10-2005-0001299 filed on Jan. 6, 2005 in the Korean Intellectual Property Office, and U.S. Provisional Patent Application No. 60/626,877 filed on Nov. 12, 2004 in the U.S. Patent and Trademark Office, the disclosures of which are incorporated herein by reference in their entirety.

### BACKGROUND OF THE INVENTION

1. Field of the Invention

Apparatuses and methods consistent with the present invention relate to a video coding/compression using a multi-layer structure, and more particularly, to facilitating a search for an intra-prediction mode in an upper layer using an intra-prediction mode in a lower layer while efficiently and compressively encoding the searched intra-prediction mode.

2. Description of the Related Art

With the development of information communication technology, including the Internet, video communication as well as text and voice communication, has increased dramatically. Conventional text communication cannot satisfy users' various demands, and thus, multimedia services that can provide various types of information such as text, pictures, and music have increased. However, multimedia data requires storage media that have a large capacity and a wide bandwidth for transmission since the amount of multimedia data is usually large. Accordingly, a compression coding method is requisite for transmitting multimedia data including text, video, and audio.

A basic principle of data compression is removing data redundancy. Data can be compressed by removing spatial redundancy in which the same color or object is repeated in an image, temporal redundancy in which there is little change between adjacent frames in a moving image or the same sound is repeated in audio, or mental visual redundancy which takes into account human eyesight and its limited perception of high frequency. In general video coding, temporal redundancy is removed by motion compensation based on motion estimation and compensation, and spatial redundancy is removed by transform coding.

Increasing attention is being directed towards H.264 or Advanced Video Coding (AVC) providing significantly improved compression efficiency over Moving Picture Experts Group (MPEG)-4 coding. H.264 is designed to improve compression efficiency and uses directional intra-prediction to remove spatial similarity within a frame.

The directional intra-prediction involves predicting values of a current sub-block by copying pixels in a predetermined direction using pixels above and to the left of this sub-block and encoding only a difference between the current sub-block and the predicted value.

In H.264, a predicted block for a current block is generated based on a previously coded block and a difference between the current block and the predicted block is finally encoded. For luminance (luma) components, a predicted block is generated for each 4×4 or 16×16 macroblock. For each 4×4 luma block, there exist nine prediction modes. For each 16×16 block, four prediction modes are available.

A video encoder compliant with H.264 selects a prediction mode of each block that minimizes a difference between a current block and a predicted block among the available prediction modes.

For prediction of the 4×4 block, H.264 uses nine prediction modes including eight directional prediction modes 0, 1, and 3 through 8 plus a DC prediction mode 2 using the average of 8 neighboring pixels as shown in FIG. 1.

FIG. 2 shows an example of labeling of prediction samples A through M for explaining the nine prediction modes. In this case, previously decoded samples A through M are used to form a predicted block (region including a through p). If samples E, F, G, and H are not available, sample D will be copied to their locations to virtually form the samples E, F, G, and H.

The nine prediction modes shown in FIG. 1 will now be described more fully with reference to FIG. 3. For mode 0 (vertical) and mode 1 (horizontal), pixels of a predicted block are formed by extrapolation from upper samples A, B, C, and D and from left samples I, J, K, and L, respectively. For mode 2 (DC), all pixels of a predicted block are predicted by a mean value of upper and left samples A, B, C, D, I, J, K, and L.

For mode 3 (diagonal down left), pixels of a predicted block are formed by interpolation at a 45-degree angle from the upper right to the lower left corner. For mode 4 (diagonal down right), pixels of a predicted block are formed by extrapolation at a 45-degree angle from the upper left to the lower right corner. For mode 5 (vertical right), pixels of a predicted block are formed by extrapolation at an approximately 26.6 degree angle (width/height=½) from the upper edge to the lower edge, slightly drifting to the right.

In mode 6 (horizontal down), pixels of a predicted block are formed by extrapolation at an approximately 26.6 degree angle from the left edge to the right edge, slightly drifting downwards. In mode 7 (vertical left), pixels of a predicted block are formed by extrapolation at an approximately 26.6 degree angle (width/height=½) from the upper edge to the lower edge, slightly drifting to the left. In mode 8 (horizontal up), pixels of a predicted block are formed by extrapolation at an approximately 26.6 degree angle (width/height=½) from the left edge to the right edge, slightly drifting upwards.

In each mode, arrows indicate the direction in which prediction pixels are derived. Samples of a predicted block can be formed from a weighted average of the reference samples A through M. For example, sample d may be predicted by the following Equation (1):
d=round(B/4+C/2+D/4) (1)
where round ( ) is a function that rounds a value to an integer value.

There are four prediction modes 0, 1, 2, and 3 for prediction of 16x 16 luma components of a macroblock. In mode 0 and mode 1, pixels of a predicted block are formed by extrapolation from upper samples H and from left samples V, respectively. In mode 2, pixels of a predicted block are computed by a mean value of the upper and left samples H and V. Lastly, in mode 3, pixels of a predicted block are formed using a linear “plane” function fitted to the upper and left samples H and V. The mode 3 is more suitable for areas of smoothly-varying luminance.

Along with efforts to improving the efficiency of video coding, research is being actively conducted into a video coding method supporting scalability that is the ability to adjust the resolution, frame rate, and signal-to-noise ratio (SNR) of transmitted video data according to various network environments.

(MPEG-21 PART-13 standardization for scalable video coding is under way. In particular, a multi-layered video coding method is widely recognized as a promising technique. For example, a bitstream may consist of multiple layers, i.e., a base layer, enhancement layer 1, and enhancement layer 2 with different resolutions (QCIF, CIF, and 2CIF) or frame rates.

Because the existing directional intra-prediction is not based on a multi-layered structure, directional search in the intra-prediction as well as coding are performed independently for each layer. Thus, in order to compatibly employ the H.264-based directional intra-prediction under multi-layer environments, there still exists a need for improvements.

It is inefficient to use intra-prediction independently for each layer because a similarity between intra-prediction modes in each layer cannot be utilized. For example, when vertical intra-prediction mode is used in a base layer, it is highly possible that intra-prediction in the vertical direction or neighboring direction will be used in a current layer. However, because a framework having a multi-layer structure while using H.264-based directional intra-prediction was recently proposed, there is an urgent need to develop an efficient encoding technique using a similarity between intra-prediction modes in each layer.

### SUMMARY OF THE INVENTION

The present invention provides a method for improving the performance of a multi-layered video codec using a similarity between intra-prediction modes in each layer during directional intra-prediction.

According to an aspect of the present invention, there is provided an intra-prediction method used in a multi-layered video encoder, the intra-prediction method including searching for an optimum prediction mode of a current block among a predetermined number of intra-prediction modes, and obtaining a directional difference between the searched optimum prediction mode and an optimum prediction mode of a lower layer block corresponding to the current block.

According to another aspect of the present invention, there is provided an intra-prediction method used in a multi-layered video encoder, the intra-prediction method including searching for an optimum prediction mode of a current block among a predetermined number of intra-prediction modes, calculating a difference D1 between the searched optimum prediction mode and a mode predicted from a neighboring block, calculating a directional difference D2 between the searched optimum prediction mode and an optimum prediction mode of a lower layer block corresponding to the current block, encoding the differences D1 and D2, and selecting a prediction method that requires a smaller number of bits to represent the encoded differences D1 and D2.

According to still another aspect of the present invention, there is provided a multi-layered video encoding method including searching for an optimum prediction mode of a current block among a predetermined number of intra-prediction modes, calculating a directional difference between the searched optimum prediction mode and an optimum prediction mode of a lower layer block corresponding to the current block, and calculating a difference between the current block and a predicted block generated using information from a neighboring block according the searched optimum prediction mode, and encoding the directional difference and the difference between the predicted block and the current block.

According to a further aspect of the present invention, there is provided a multi-layered video decoding method including performing lossless decoding on an input bitstream to extract a directional difference associated with an intra-prediction mode and texture data, performing inverse quantization on the extracted texture data, reconstructing residual blocks in a spatial domain from coefficients generated using the inverse quantization, calculating an intra-prediction mode of a current residual block from an optimum intra-prediction mode of a lower layer block corresponding to the residual block and the directional difference associated with the intra-prediction mode, and reconstructing a video frame from the residual block according to the calculated intra-prediction mode.

According to yet another aspect of the present invention, there is provided a multi-layered video encoder including means for searching for an optimum prediction mode of a current block among a predetermined number of intra-prediction modes, means for calculating a directional difference between the searched optimum prediction mode and an optimum prediction mode of a lower layer block corresponding to the current blocks, means for calculating a difference between the current block and a predicted block generated using information from a neighboring block according the searched optimum prediction mode, and means for encoding the directional difference and the difference between the predicted block and the current block.

According to a further aspect of the present invention, there is provided a multi-layered video decoder including means for performing lossless decoding on an input bitstream to extract a directional difference associated with an intra-prediction mode and texture data, means for performing inverse quantization on the extracted texture data, means for reconstructing residual blocks in a spatial domain from coefficients generated using the inverse quantization, means for calculating an intra-prediction mode of a current residual block from an optimum intra-prediction mode of a lower layer block corresponding to the residual block and the directional difference associated with the intra-prediction mode, and means for reconstructing a video frame from the residual block according to the calculated intra-prediction mode.

### BRIEF DESCRIPTION OF THE DRAWINGS

The above and other aspects of the present invention will become more apparent by describing in detail exemplary embodiments thereof with reference to the attached drawings in which:

FIG. 1 illustrates the directions of predictions in conventional intra-prediction modes;

FIG. 2 shows an example of labeling of prediction samples for explaining the intra-prediction modes shown in FIG. 1;

FIG. 3 is a detailed diagram of the intra-prediction modes shown in FIG. 1;

FIG. 4A illustrates a method for performing a search for a mode whose direction is adjacent to a vertical direction in a current layer when the optimum prediction mode of an intra-block at the same position in a lower layer is a vertical mode (mode 0);

FIG. 4B illustrates a block in an upper layer corresponding to that in a lower layer when the upper layer has different resolution than the lower layer;

FIG. 5 is a diagram for explaining neighboring modes to each of eight directional intra-prediction modes;

FIG. 6 is a block diagram of a video encoder according to an exemplary embodiment of the present invention;

FIG. 7 shows an example of selecting one from three prediction methods;

FIG. 8 is a block diagram of a video decoder according to an exemplary embodiment of the present invention;

FIG. 9 is a flowchart illustrating a process of performing intra mode prediction according to a first exemplary embodiment of the present invention;

FIG. 10 shows an example of spatial mode prediction;

FIG. 11 is a flowchart illustrating a process of performing intra mode prediction according to a second exemplary embodiment of the present invention; and

FIG. 12 is a flowchart illustrating a process of performing intra mode prediction according to a third exemplary embodiment of the present invention.

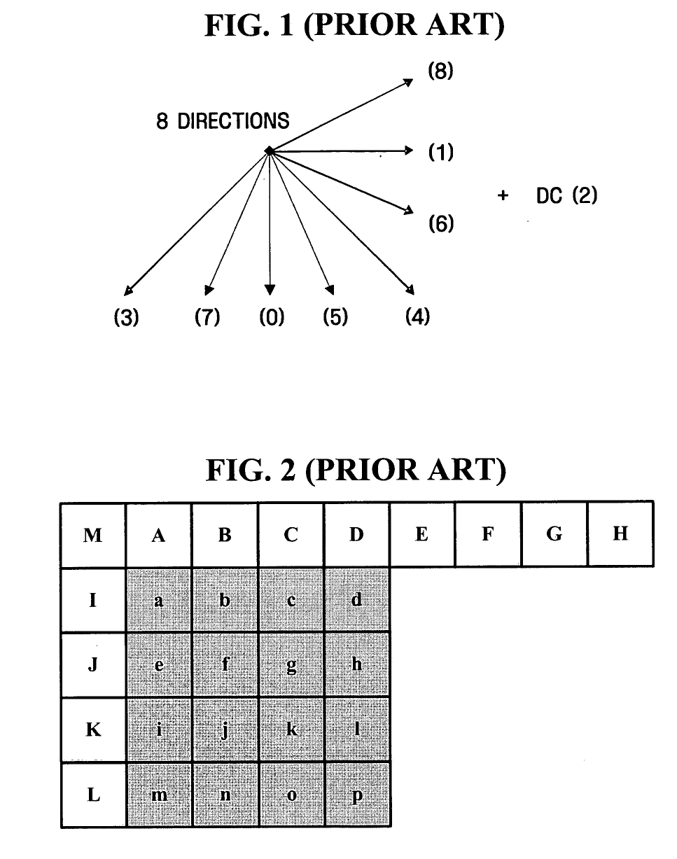

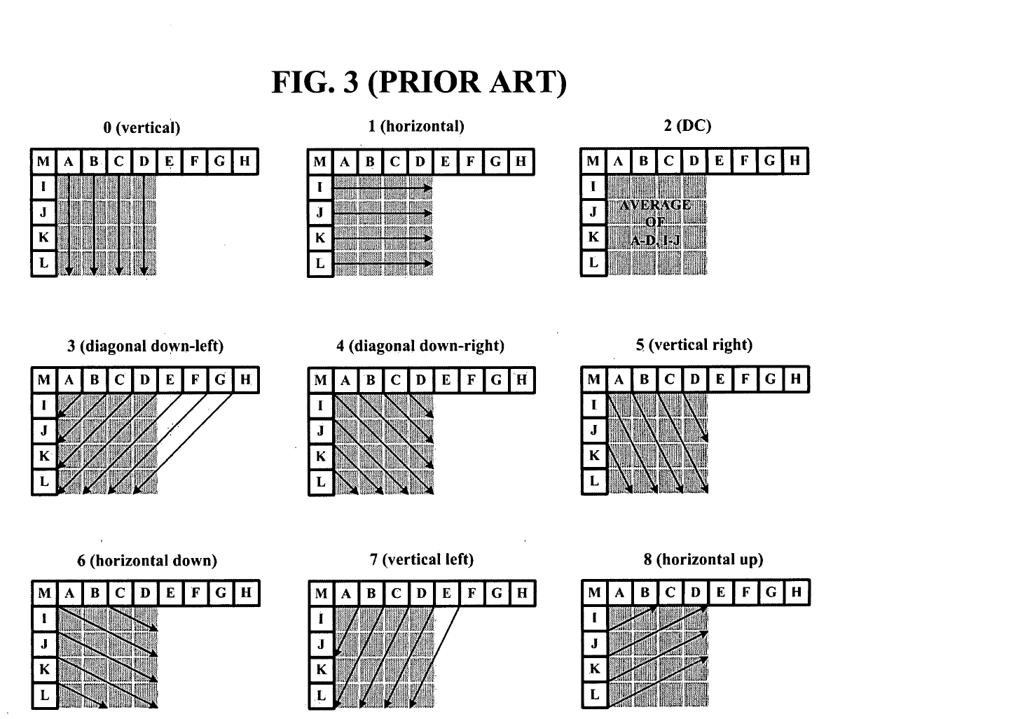

### DETAILED DESCRIPTION OF EXEMPLARY EMBODIMENTS OF THE INVENTION

The present invention will now be described more fully with reference to the accompanying drawings, in which exemplary embodiments of the invention are shown. Advantages and features of the present invention and methods of accomplishing the same may be understood more readily by reference to the following detailed description of exemplary embodiments and the accompanying drawings. The present invention may, however, be embodied in many different forms and should not be construed as being limited to the exemplary embodiments set forth herein. Rather, these exemplary embodiments are provided so that this disclosure will be thorough and complete and will fully convey the concept of the invention to those skilled in the art, and the present invention will only be defined by the appended claims. Like reference numerals refer to like elements throughout the specification.

There are two types of data to be encoded as a result of intra-prediction; texture data of a “residual block” generated by a difference between a block predicted from neighboring blocks and a current block and data indicating intra-prediction modes that have been selected for each block (hereinafter called “prediction modes”). An intra-prediction method proposed in the present invention relates to a method for efficiently predicting/compressing an intra-prediction mode of each block (hereinafter called “mode prediction”). The present invention also uses a conventional intra-prediction method in H.264 for predicting/compressing texture data for each block. The term “block” used herein encompasses a macroblock and sub-blocks (8×8, 4×4, or the like) within the macroblock.

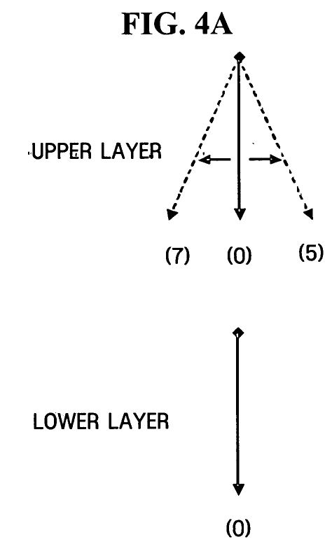

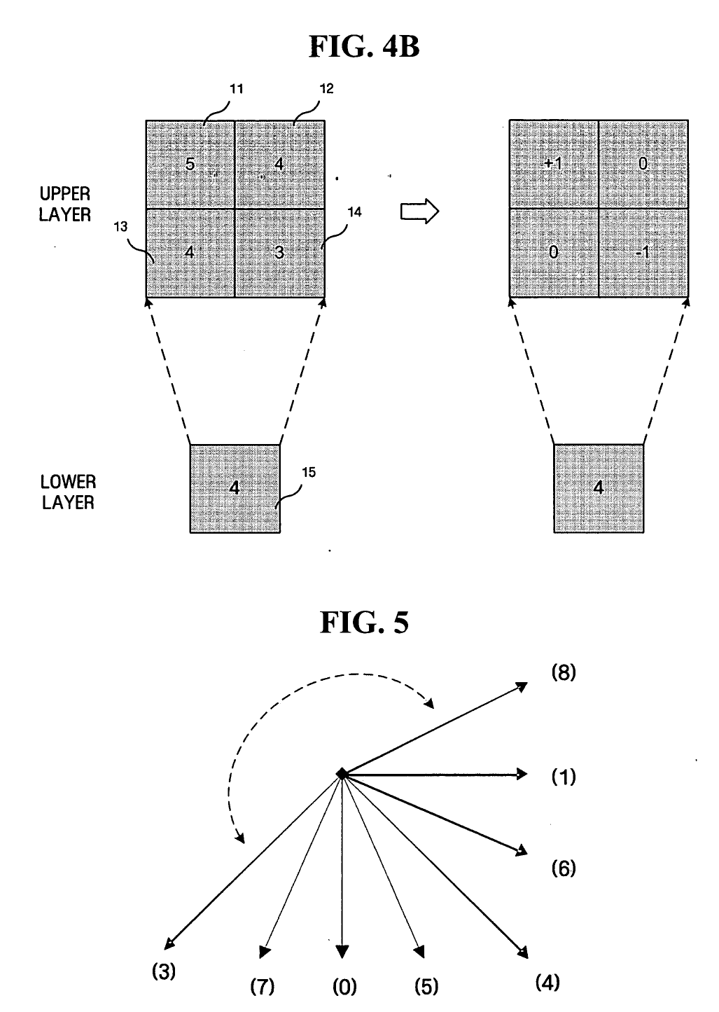

FIG. 4A illustrates a method for performing a search for a mode whose direction is adjacent to a vertical direction in a current layer when an optimum prediction mode of an intra-block at the same position in a lower layer is a vertical mode (mode 0). That is, because the direction of prediction in the optimum prediction mode in a base layer is a vertical direction, it is highly possible that an optimum intra-prediction mode in a current layer will be a vertical mode (mode 0), a vertical left mode (mode 7), or a vertical right mode (mode 5). Thus, a search can be performed for only these directional modes to reduce the amount of computation during intra-prediction. Furthermore, the number of bits required for encoding the optimum prediction mode can be efficiently reduced by representing modes having a clockwise adjacent direction, a counter-clockwise adjacent direction, and the same direction by −1, +1, and 0, respectively, and encoding the same.

In this way, a prediction mode can be represented by a difference considering only its direction regardless of a mode number. The difference is called a “directional difference.” For example, when mode 0 is represented by directional difference 0, mode 6 and mode 3 may be respectively represented by directional differences +3 and −2.

FIG. 5 is a diagram for explaining neighboring modes to each of eight directional intra-prediction modes. Referring to FIG. 5, neighboring modes to mode 7 are modes 0 and 3 and neighboring modes to mode 0 are modes 5 and 7. In the present invention, neighboring modes refer to two modes closest to a specific mode in clockwise and counter-clockwise directions regardless of a distance from the specific mode.

Thus, neighboring modes to mode 3 are modes 8 and 7 and the neighboring modes to mode 8 are modes 1 and 3. In this way, neighboring modes to a specific mode can be represented by either −1 or +1 and this can apply in the same manner to all the directional intra-prediction modes. However, because mode 3 is actually in nearly the opposite direction to mode 8, they are not deemed to fall within a prediction range. Thus, mode 3 and mode 8 can be understood to have only one neighboring mode. In this case, neighboring modes to mode 3 and mode 8 are mode 7 and mode 1, respectively.

While it is described above that “neighboring modes” refer to one mode closest to a specific mode in either the clockwise or counter-clockwise direction, they can be defined as two (or more) modes closest to the specific mode in either direction. For example, mode 0 may have neighboring modes 3, 7, 5, and 4.

While FIG. 4A shows that the search is performed for only modes adjacent to the optimum prediction mode in the lower layer to determine the optimum prediction mode in the current layer (“first exemplary embodiment”), an alternative method is to search all prediction modes for the optimum prediction mode in the current layer and represent the searched optimum prediction mode by a directional difference from the optimum prediction mode in the lower layer (“second exemplary embodiment”).

While conventional H.264 intra-prediction involved predicting an optimum prediction mode in a current block from optimum prediction mode in a neighboring subblock and encoding a difference between the predicted block and current block, the present invention using a multi-layer structure improves coding performance by encoding a directional difference from the optimum prediction mode in a corresponding lower layer block. The directional difference is represented by a value relative to the optimum prediction mode in the corresponding lower layer block. For example, modes located in the clockwise and counter-clockwise directions relative to the optimum prediction mode in the lower layer block can be respectively represented by negative and positive values. A mode at the same position as the optimum prediction mode in the lower layer block can be represented by 0.

However, when the current layer has a different resolution than the lower layer, lower layer blocks do not correspond one-to-one to current blocks. Referring to FIG. 4B, when a lower layer has half the resolution of a current layer, one block 15 in the lower layer corresponds to four blocks 11 through 14 in the current layer. Thus, it should be noted that the block 15 corresponds to each of the four blocks 11 through 14 in the current layer.

In this way, a mode prediction method proposed in the present invention (hereinafter called “inter-layer mode prediction”) can be combined with a conventional method for predicting/compressing an optimum prediction mode in a current block from an optimum prediction mode in a neighboring block (hereinafter called “spatial mode prediction”) like H.264 intra-prediction. That is, the conventional method can be used when a corresponding lower layer block is not an intra block or uses a non-directional mode (DC mode) while the mode prediction method of the present invention can be used when the lower layer block uses a directional mode.

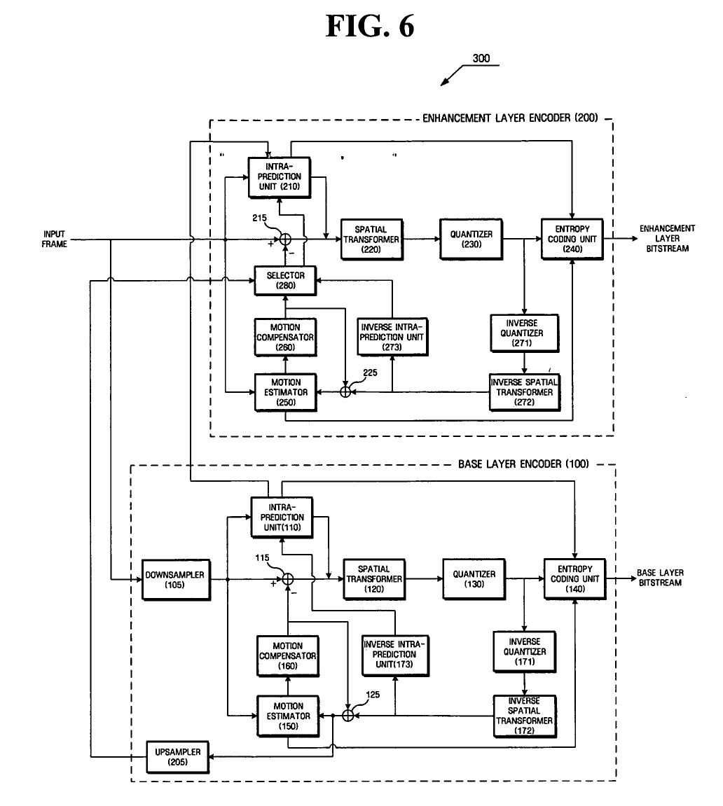

FIG. 6 is a block diagram of a video encoder 300 according to an exemplary embodiment of the present invention. Referring to FIG. 6, the video encoder 300 includes a base layer encoder 100 and an enhancement layer encoder 200.

The enhancement layer encoder 200 includes an intra-prediction unit 210, a spatial transformer 220, a quantizer 230, an entropy coding unit 240, a motion estimator 250, a motion compensator 260, a selector 280, an inverse quantizer 271, an inverse spatial transformer 272, and an inverse intra-prediction unit 273.

The selector 280 selects the best prediction method among intra-prediction, B-intra-prediction, and temporal prediction. This selection may be made on a macroblock, slice, or frame basis. To achieve this function, the selector 280 respectively receives a corresponding base layer frame, a frame reconstructed after being encoded by temporal prediction, and a frame reconstructed after being encoded by intra-prediction from an upsampler 205 of the base layer encoder 100, an adder 225, and the inverse intra-prediction unit 273.

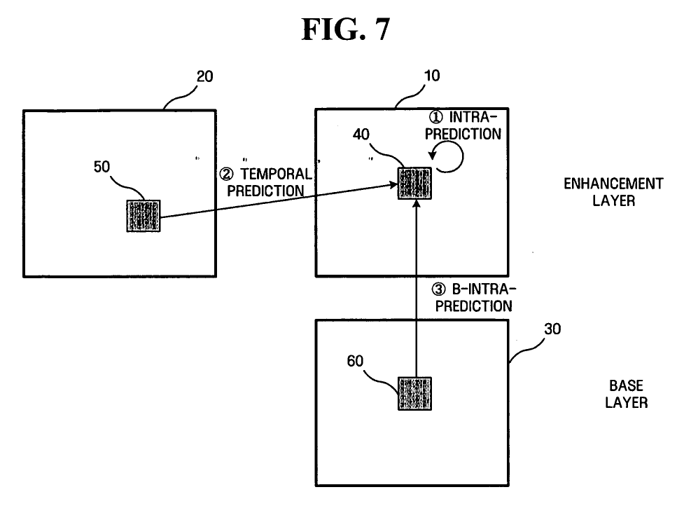

FIG. 7 shows an example of selecting a prediction method. There are three prediction methods: \textcircled{1} intra-prediction performed on a macroblock 40 in a current frame 10; \textcircled{2} temporal prediction performed using a frame 20 at a different temporal position than the current frame 10; and \textcircled{3} B-intra-prediction performed using texture data of a region 60 corresponding to the macroblock 40 in the base layer frame 30 at the same temporal position as the current frame 10.

Of course, when one of the three prediction methods is selected for each macroblock, motion estimation may not be necessarily performed on a macroblock basis during temporal prediction. The motion estimation may be performed on a subblock basis in order to obtain the optimum coding efficiency. Similarly, intra-prediction may be performed for each 16×16 macroblock or each 4×4 sub-block of the macroblock to select the optimum prediction mode that offers the optimum efficiency. To compare the three prediction methods with one another, the optimum prediction mode is determined for each prediction method.

In general, both temporal similarity and spatial similarity are employed for encoding a moving image. A method of encoding a moving image using temporal similarity involves obtaining a predicted signal from a reference frame using motion vectors searched through a motion search and encoding only a residual signal between the predicted signal and an original frame. A method of encoding a moving image using spatial similarity involves predicting a current sub-block from neighboring pixels or blocks within a frame and encoding a difference between the predicted value and the original sub-block. The former is called temporal prediction or inter-prediction while the latter is called intra-prediction.

Furthermore, a multi-layered video codec in which an enhancement layer is coded/decoded using information from a base layer may use B-intra-prediction that uses a base layer block corresponding to an enhancement layer block as a predicted block to encode only a difference between the enhancement layer block and the predicted block. Thus, the selector 280 selects the best one from the three prediction methods. Of course, for a block to which temporal prediction cannot be applied, the selector 280 selects either intra-prediction or B-intra-prediction. When there is no lower layer frame corresponding to an upper layer frame due to a frame rate difference between layers, the selector 280 may choose either intra-prediction or temporal prediction.

The selector 280 selects the best method that offers a minimum cost after performing encoding using the three prediction methods. Here, a cost C may be defined in various ways and representatively calculated by Equation (2) based on rate-distortion (RD) optimization:
C=E+λB (2)
where E is a difference between an original signal and a signal reconstructed by decoding encoded bits, B is the number of bits required to perform each prediction method and λ is a Lagrangian coefficient used to control the ratio of E to B.

The intra-prediction unit 210 performs a search for an optimum prediction mode of a current block among a predetermined number of intra-prediction modes and calculates a difference between the current block and a predicted block obtained from the searched optimum prediction mode. Here, the predetermined number of intra-prediction modes mean the optimum prediction mode in a base layer and neighboring modes for the first exemplary embodiment and all intra-prediction modes for the second exemplary embodiment. For example, to find the optimum prediction mode among the predetermined number of intra-prediction modes, the intra-prediction unit 210 may calculate a difference between the current block and the predicted block for each intra-prediction mode and determines a prediction mode that minimizes the difference as the optimum prediction mode. Minimizing the difference leads to a reduction in the number of bits through accurate prediction.

The intra-prediction unit 210 also calculates a directional difference between the optimum prediction mode of the current block and optimum prediction mode of a corresponding base layer block. The optimum prediction mode of the base layer block is determined by an intra-prediction unit 110 in the base layer encoder 100 before being sent to the intra-prediction unit 210. The directional difference is then sent to the entropy coding unit 240.

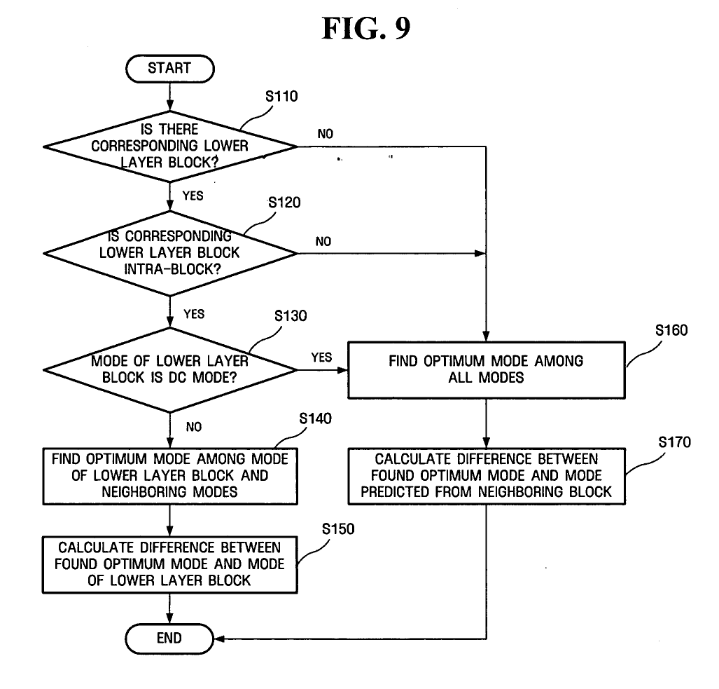

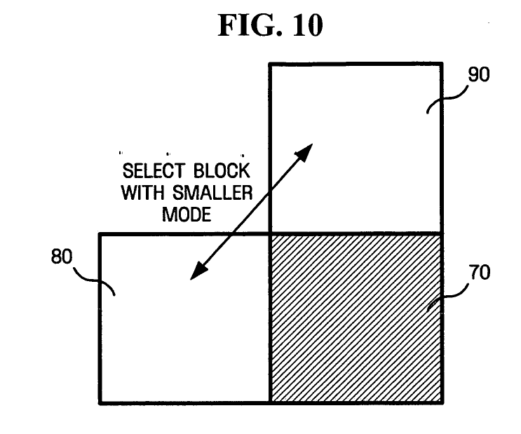

A process of predicting the optimum prediction for the current block in the intra-prediction unit 210 will later be described in more detail with reference to FIGS. 9 through 12.

The motion estimator 250 performs motion estimation on a current frame among input video frames using a reference frame to obtain motion vectors. A block matching algorithm (BMA) has been widely used in the motion estimation. In the BMA, pixels in a given motion block are compared with pixels of a search area in a reference frame and a displacement with a minimum error is determined as a motion vector. While a fixed-size motion block is used for motion estimation, the motion estimation may make use of a hierarchical variable size block matching (HVSBM) technique using a variable size motion block. The motion estimator 250 sends motion data such as motion vectors obtained as a result of motion estimation, a motion block size, and a reference frame number to the entropy coding unit 240.

The motion compensator 260 reduces temporal redundancy within the input video frame. In this case, the motion compensator 260 performs motion compensation on a reference frame uses the motion vectors calculated by the motion estimator 250 and generates a temporally predicted frame for a current frame.

A subtractor 215 calculates a difference between the current frame and the temporally predicted frame in order to remove temporal redundancy within the input video frame.

The spatial transformer 220 uses spatial transform technique supporting spatial scalability to remove spatial redundancy within a frame in which temporal redundancy has been removed by the subtractor 215. Discrete Cosine Transform (DCT) or wavelet transform technique may be used for the spatial transform.

The spatial transformer 220 performs the spatial transform to create transform coefficients. A DCT coefficient is created when DCT is used for the spatial transform while a wavelet coefficient is produced when wavelet transform is used.

The quantizer 230 applies quantization to the transform coefficient obtained by the spatial transformer 220. Quantization is the process of converting real-valued transform coefficients into discrete values by dividing the range of coefficients into a limited number of intervals and mapping the real-valued coefficients into quantization indices. In particular, embedded quantization is mainly used when wavelet transform is used for spatial transform. The embedded quantization exploits spatial redundancy and involves reducing a threshold value by one half and encoding a transform coefficient larger than the threshold value. Examples of embedded quantization techniques include Embedded ZeroTrees Wavelet (EZW), Set Partitioning in Hierarchical Trees (SPIHT), and Embedded ZeroBlock Coding (EZBC).

The entropy coding unit 240 losslessly encodes the transform coefficients quantized by the quantizer 230, the motion data received from the motion estimator 250, and the directional difference received from the intra-prediction unit 210 into an output bitstream. Various coding schemes such as Huffman Coding, Arithmetic Coding, and Variable Length Coding may be employed for lossless coding.

To support closed-loop encoding in order to reduce a drifting error caused due to a mismatch between an encoder and a decoder, the video encoder 300 further includes the inverse quantizer 271, the inverse spatial transformer 272, and the inverse intra-prediction unit 273.

The inverse quantizer 271 performs inverse quantization on the coefficient quantized by the quantizer 230. The inverse quantization is the inverse of the quantization process.

The inverse spatial transformer 272 performs inverse spatial transform on the inversely quantized result and sends the inversely spatially transformed result to the adder 225 or the inverse intra-prediction unit 273. That is, when a residual frame reconstructed by the inverse spatial transform is originally generated using intra-prediction, the residual frame is fed to the inverse intra-prediction unit 273. A residual frame originally generated using temporal prediction is fed to the adder 225.

The adder 225 adds the residual frame received from the inverse spatial transformer 272 to a previous frame received from the motion compensator 260 and stored in a frame buffer (not shown), thereby reconstructing a video frame that is then sent to the motion estimator 250 as a reference frame.

The inverse intra-prediction unit 273 calculates a prediction mode of a current residual block from an optimum prediction mode of a lower layer block corresponding to a residual block in the residual frame and the directional difference. This calculation is the process of searching for a prediction mode that will be obtained by moving the optimum prediction mode of the lower layer block by the directional difference. For example, when the optimum prediction mode of the lower layer block is mode 4 and the directional difference is -2 in FIG. 5, the optimum prediction mode of the current block is mode 0 (vertical mode) obtained by moving the mode 4 by 2 in the clockwise direction.

The inverse intra-prediction unit 273 also adds residual blocks in the residual frame received from the inverse spatial transformer 272 to the previously reconstructed neighboring blocks according to the obtained optimum prediction mode to reconstruct a video frame.

On the other hand, the base layer encoder 100 includes an intra-prediction unit 110, a spatial transformer 120, a quantizer 130, an entropy coding unit 140, a motion estimator 150, a motion compensator 160, an inverse quantizer 171, an inverse spatial transformer 172, an inverse intra-prediction unit 173, a downsampler 105, and an upsampler 205. While FIG. 6 shows the base layer encoder 100 includes the upsampler 205, the upsampler 205 may be located anywhere within the video encoder 300.

The downsampler 105 downsamples an original input frame to the resolution of a base layer. Of course, when the base layer has the same resolution as the enhancement layer, downsampling is skipped.

The upsampler 205 upsamples a signal output from an adder 125, i.e., a reconstructed video frame, when needed and provides an upsampled version of the video frame to the selector 280 of the enhancement layer encoder 200. Of course, when the base layer has the same resolution as the enhancement layer, the upsampler 205 may not be needed.

The intra-prediction unit 110 performs substantially the same function as the intra-prediction unit 210, except that it cannot perform intra-prediction on a current layer using a lower layer because there is no lower layer than the base layer. The intra-prediction unit 110 provides an optimum prediction mode of a base layer block requested by the intra-prediction unit 210.

Since other elements such as the spatial transformer 120, the quantizer 130, the entropy coding unit 140, the motion estimator 150, the motion compensator 160, the inverse quantizer 171, the inverse spatial transformer 172, the inverse intra-prediction unit 173 perform the same operation as their counterparts in the enhancement layer encoder 200, a detailed explanation thereof will not be given.

While FIG. 6 shows the video encoder 300 includes a plurality of elements having the same name but different reference numerals, it will be obvious to those skilled in the art that a single element with a specific name can process operation at both the base layer and the enhancement layer.

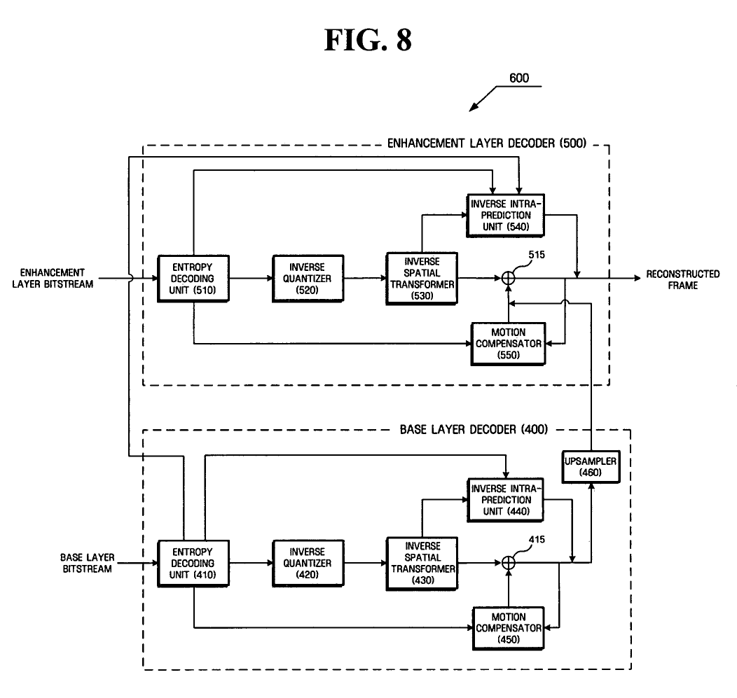

FIG. 8 is a block diagram of a video decoder 600 according to an exemplary embodiment of the present invention. Referring to FIG. 8, the video decoder 600 includes a base layer decoder 400 and an enhancement layer decoder 500. The enhancement layer decoder 500 includes an entropy decoding unit 510, an inverse quantizer 520, an inverse spatial transformer 530, an inverse intra-prediction unit 540, and a motion compensator 550.

The entropy decoding unit 510 performs lossless decoding that is the inverse of entropy encoding to extract motion data, directional difference associated with an intra-prediction mode, and texture data that are then fed to the motion compensator 550, the inverse intra-prediction unit 540, and the inverse quantizer 520, respectively.

The inverse quantizer 520 performs inverse quantization on the texture data received from the entropy decoding unit 510. The inverse quantization is the process of obtaining quantized coefficients from matching quantization indices received from the encoder (300 of FIG. 6). A mapping table between indices and quantized coefficients may be received from the encoder 300 or be predetermined between the encoder 300 and the decoder 600.

The inverse spatial transformer 530 performs inverse spatial transform on coefficients obtained after the inverse quantization to reconstruct a residual image in a spatial domain. For example, when wavelet transform is used for spatial transform at the video encoder 300, the inverse spatial transformer 530 performs inverse wavelet transform. When DCT is used for spatial transform, the inverse spatial transformer 530 performs inverse DCT.

The intra-prediction unit 540 calculates an optimum intra-prediction mode of a current block using the directional difference for the current block and an optimum intra-prediction mode of a base layer block corresponding to the current. block received from the entropy decoding unit 510 and an entropy decoding unit 410 of the base layer decoder 400, respectively. For example, when the optimum prediction mode of the base layer block is mode 5 and the directional difference for the current block is -1 in FIG. 5, the optimum prediction mode of the current block is mode 0.

The intra-prediction unit 540 also adds the reconstructed residual image (residual image for a specific block) received from the inverse spatial transformer 530 to the previously reconstructed texture data of neighboring blocks according to the obtained optimum prediction mode in order to reconstruct a video frame. The entire macroblock can be reconstructed from a plurality of reconstructed sub-blocks and a frame or slice can be reconstructed from a plurality of reconstructed macroblocks.

The motion compensator 550 performs motion compensation on the previously reconstructed video frame using the motion data from the entropy decoding unit 510 and generates a motion-compensated frame. Of course, the motion compensation can be applied only when the current frame is encoded by the encoder 300 using temporal prediction.

When the residual image reconstructed by the inverse spatial transformer 530 is originally generated using temporal prediction, the adder 515 adds the residual image to the motion-compensated frame received from the motion compensator 550 in order to reconstruct a video frame. On the other hand, when the residual image is originally created using B-intra-prediction, the adder 515 adds a corresponding reconstructed base layer image received from an upsampler 460 of the base layer decoder 400 to the residual image in order to reconstruct a video frame.

Meanwhile, the base layer encoder 400 includes an entropy decoding unit 410, an inverse quantizer 420, an inverse spatial transformer 430, an inverse intra-prediction unit 440, a motion compensator 450, and an upsampler 460.

The entropy decoding unit 410 performs lossless decoding that is the inverse of entropy encoding to extract motion data, the optimum intra-prediction mode in the base layer, and texture data that are then fed to the motion compensator 450, the inverse intra-prediction unit 440, and the inverse quantizer 420, respectively.

The upsampler 460 upsamples a base layer image reconstructed by the base layer decoder 400 to the resolution of an enhancement layer and provides an upsampled version of the reconstructed base layer image to an adder 415. Of course, when the base layer has the same resolution as the enhancement layer, the upsampling operation may be skipped.

The inverse intra-prediction unit 440 performs substantially the same function as the inverse intra-prediction unit 540, except that it cannot reconstruct the optimum intra-prediction mode in the base layer using an optimum prediction mode in a lower layer because there is no lower layer than the base layer.

Since other elements such as the inverse quantizer 420, the inverse spatial transformer 430, and the motion compensator 450 perform the same operation as their counterparts in the enhancement layer decoder 500, a detailed explanation thereof will not be given.

While FIG. 8 shows the video decoder 600 includes a plurality of elements having the same name but different reference numerals, it will be readily apparent to those skilled in the art that a single element with a specific name can process operations performed by both the base layer and the enhancement layer.

In FIGS. 6 through 8, various components mean, but are not limited to, software or hardware components, such as a Field Programmable Gate Arrays (FPGAs) or Application Specific Integrated Circuits (ASICs), which perform certain tasks. The components may advantageously be configured to reside on the addressable storage media and configured to be executed on one or more processors. The functionality provided for in the components and modules may be combined into fewer components and modules or further separated into additional components and modules.

FIG. 9 is a flowchart illustrating a process of performing intra mode prediction according to a first exemplary embodiment of the present invention.

Referring to FIGS. 6 and 9, in operation S140, when there is a lower layer block corresponding to a current layer block (YES in operation S110), the lower layer block is an intra-block (YES in operation S120), and an intra-prediction mode of the lower layer block is a directional mode (that is, not a DC mode) (YES in operation S130), the intra-prediction unit 210 finds an optimum prediction mode among the intra-prediction mode of the lower layer block and its neighboring modes. The optimum prediction mode can be determined by calculating a difference between the current block and a predicted block for each of the plurality of intra-prediction modes and selecting a mode that minimizes the difference.

In operation S150, the intra-prediction unit 210 calculates a directional difference between the searched optimum prediction mode and the intra-prediction mode of the lower layer block. In this case, the directional difference can be represented by −1, 0, or 1 because the search for the optimum prediction mode is performed only among the intra-prediction mode of the lower layer block and neighboring modes.

On the other hand, when there is no lower layer block corresponding to the current layer block (NO in operation S110) and the lower layer block is an inter-block (NO in operation S120), conventional spatial mode prediction can be performed instead of inter-layer mode prediction because there is no intra-prediction mode of the base layer block. In this case, the intra-prediction unit 210 uses spatial mode prediction to perform a search for an optimum prediction mode among all intra-prediction modes 0 through 8 in operation S160 and calculate a difference between the searched optimum prediction mode and a mode predicted from neighboring blocks in operation S170.

The spatial mode prediction will now be described in detail with reference to FIG. 10. When intra-prediction modes for blocks 90 and 80 above and to the left of a current block 70 are determined, an intra-prediction mode of the current block 70 can be efficiently and compressively represented considering the intra-prediction modes for the upper and left blocks 90 and 80. The intra-prediction mode of the current block 70 is predicted from either the upper and left blocks 90 or 80 having a smaller mode. When the intra-prediction mode of a reference block is the same as that for the current block, the intra-prediction prediction mode of the current block is represented by 1. When the former is different from the latter, the intra-prediction mode of the current block is represented by 0 plus the intra-prediction mode number for the current block. For example, if modes for the left block 80, the upper block 90, and the current block 70 are respectively 5, 8, and 5, the intra-prediction mode of the current block 70 may be simply set to “1” (1 bit). However, if the mode for the current block is 6, it must be set to (0,6).

The spatial mode prediction is an example of a prediction method actually used in a H.264 codec. Thus, prediction may be performed using neighboring blocks in various other ways, depending on the type of application. For example, it will be obvious to those skilled in the art that a difference between a rounded value of a mean of modes for upper and left blocks and a mode for a current block may be encoded.

Referring to FIG. 9, when the mode for the corresponding lower layer block is a DC mode that is a non-directional in operation S130, it is not easy to predict the direction of motion of the current block. Thus, in this case, the spatial mode prediction (steps S160 and 170) may be used. Alternatively, because there is a neighboring mode to the DC mode, the optimum prediction mode of the current block may be determined as the DC mode.

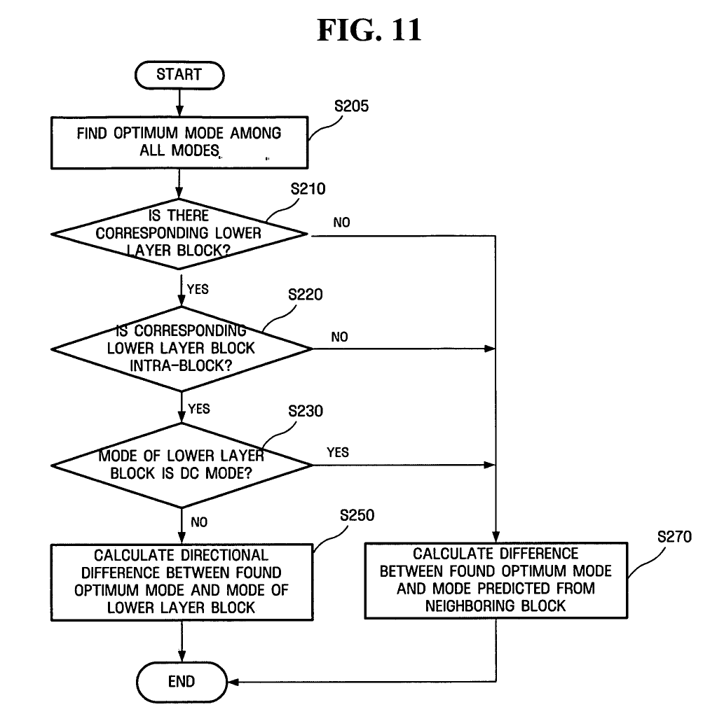

FIG. 11 is a flowchart illustrating a process of performing intra mode prediction according to a second exemplary embodiment of the present invention. The biggest difference from the first exemplary embodiment is that a search for an optimum prediction mode is performed among all modes in operation S205. Although the optimum prediction mode obtained using a prediction mode in a lower layer is represented by a directional difference during quantization, the directional difference can be set to −1, 0, 1, and other integers.

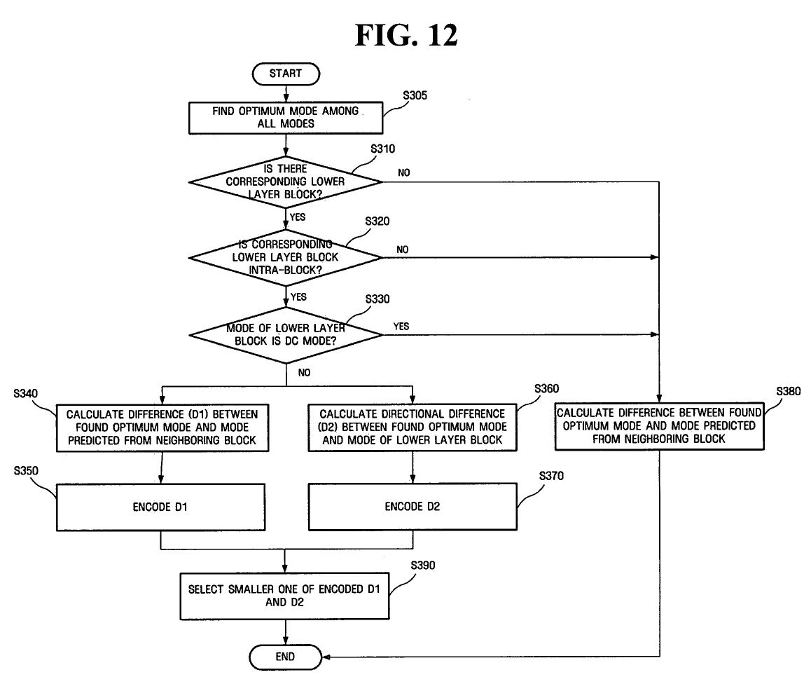

FIG. 12 is a flowchart illustrating a process of performing intra mode prediction according to a third exemplary embodiment of the present invention. Unlike in the first and second exemplary embodiments, the prediction process according to the third exemplary embodiment is to select a better one of inter-layer mode prediction and spatial mode prediction for each sub-block or macroblock and encode an intra-prediction mode using the selected approach. In this case, a market bit (e.g., 1-bit flag) is needed to inform a decoder which of the two mode prediction methods is used to encode each block.

Referring to FIGS. 6 and 12, in operation S305, the intra-prediction unit 210 performs a search for an optimum prediction mode of a current block among all modes. When there is a lower layer block corresponding to the current block (YES in operation S310), the lower layer block is an intra-block (YES in operation S320), and an intra-prediction mode of the lower layer block is not a DC mode (NO in operation S330), the intra-prediction unit 210 performs both inter-layer mode prediction and spatial mode prediction to select a better one.

The intra-prediction unit 210 calculates a difference D1 between the searched optimum prediction mode and a mode predicted from neighboring blocks in operation S340 and encodes the difference D1 in operation S350. The intra-prediction unit 210 also calculates a directional difference D2 between the searched optimum prediction mode and a mode for the lower layer block in operation S360 and encodes the directional difference D2 in operation S370. Then, in operation S390, the intra-prediction unit 210 selects a smaller one of the encoded differences D1 and D2. The market bit is set to “0” when the encoded difference D1 is selected while it is set to “1” when the encoded difference D2 is selected.

While all the exemplary embodiments described above employ a multi-layer structure including one base layer and one enhancement layer, two or more enhancement layers may be used. Thus, when the multi-layer structure includes a base layer, a first enhancement layer, and a second enhancement layer, an algorithm used between the base layer and the first enhancement layer may be applied in the same manner between the first and second enhancement layers.

A video codec having a multi-layer structure uses directional intra-prediction to improve the coding performance when temporal similarity is low but spatial similarity is high due to the presence of fast motion. The present invention provides improved encoding speed using correlation with an intra-prediction mode in a lower layer during directional intra-prediction. The present invention also allows an intra-prediction mode determined in a current layer to be represented by a smaller number of bits.

Although the present invention has been described in connection with the exemplary embodiments of the present invention, it will be apparent to those skilled in the art that various modifications and changes may be made thereto without departing from the scope and spirit of the invention. Therefore, it should be understood that the above exemplary embodiments are not limitative, but illustrative in all aspects.

What is claimed is:

1. An intra-prediction method used in a multi-layered video encoder, the method comprising:
searching for an optimum prediction mode of a current block among a predetermined number of intra-prediction modes; and
obtaining a directional difference between the searched optimum prediction mode and an optimum prediction mode of a lower layer block corresponding to the current block.

2. The method of claim 1, wherein the predetermined number of intra-prediction modes include the optimum prediction mode of the lower layer block corresponding to the current block and its neighboring modes.

3. The method of claim 1, further comprising obtaining a difference between the current block and a predicted block generated using information from neighboring blocks according to the searched optimum prediction mode.

4. The method of claim 1, wherein the neighboring modes include one mode closest to a specific mode in a clockwise direction or a counter-clockwise direction.

5. The method of claim 4, wherein the directional difference is one of −1, 0, and 1.

6. The method of claim 1, wherein if the optimum prediction mode of the lower layer block is a DC mode, the optimum prediction mode of the current block is set to a DC mode.

7. The method of claim 1, further comprising predicting the searched optimum prediction mode of the current block from an optimum prediction mode of a neighboring block to the current block if the lower layer block is not an intra-block or has a DC mode.

8. An intra-prediction method used in a multi-layered video encoder, the method comprising:
searching for an optimum prediction mode of a current block among a predetermined number of intra-prediction modes;
calculating a difference D1 between the searched optimum prediction mode and a mode predicted from a neighboring block;
calculating a directional difference D2 between the searched optimum prediction mode and an optimum prediction mode of a lower layer block corresponding to the current block;
encoding the differences D1 and D2; and
selecting a prediction method that requires a smallest number of bits to represent the encoded differences D1 and D2.

9. A multi-layered video encoding method comprising:
searching for an optimum prediction mode of a current block among a predetermined number of intra-prediction modes;
calculating a directional difference between the searched optimum prediction mode and an optimum prediction mode of a lower layer block corresponding to the current block;
calculating a difference between the current block and a predicted block generated using information from a neighboring block according the searched optimum prediction mode; and
encoding the directional difference and the difference between the predicted block and the current block.

10. The method of claim 9, wherein the predetermined number of intra-prediction modes include the optimum prediction mode of the lower layer block corresponding to the current block and its neighboring modes.

11. The method of claim 10, wherein the neighboring modes include one mode closest to a specific mode in a clockwise direction or a counter-clockwise direction.

12. The method of claim 11, wherein the directional difference is one of −1, 0, and 1.

13. The method of claim 9, wherein the encoding of the directional difference and the difference between the predicted block and the current block comprises:
performing spatial transform on the difference between the predicted block and the current block to create a transform coefficient;
quantizing the transform coefficient to produce a quantization coefficient; and
losslessly encoding the quantization coefficient and the directional difference.

14. A multi-layered video decoding method comprising:
performing lossless decoding on an input bitstream to extract a directional difference associated with an intra-prediction mode and texture data;
performing inverse quantization on the extracted texture data;
reconstructing residual blocks in a spatial domain from coefficients generated using the inverse quantization;
calculating an intra-prediction mode of a current residual block from an optimum intra-prediction mode of a lower layer block corresponding to the residual block and the directional difference associated with the intra-prediction mode; and
reconstructing a video frame from the residual block according to the calculated intra-prediction mode.

15. The method of claim 14, wherein the calculating of the intra-prediction mode of the current residual block comprises searching for an optimum prediction mode that is obtained by moving the optimum prediction mode of the lower layer block by the directional difference.

16. The method of claim 15, wherein the reconstructing of the video frame comprises adding the reconstructed residual block to the previously reconstructed texture data of a neighboring block to the residual image according to the calculated intra-prediction mode.

17. The method of claim 4, wherein the directional difference has one of −1, 0, and 1.

18. A multi-layered video encoder comprising:
means for searching for an optimum prediction mode of a current block among a predetermined number of intra-prediction modes;
means for calculating a directional difference between the searched optimum prediction mode and an optimum prediction mode of a lower layer block corresponding to the current block;
means for calculating a difference between the current block and a predicted block generated using information from a neighboring block according the searched optimum prediction mode; and
means for encoding the directional difference and the difference between the predicted block and the current block.

19. The video encoder of claim 18, wherein the predetermined number of intra-prediction modes include the optimum prediction mode of the lower layer block corresponding to the current block and its neighboring modes.

20. The video encoder of claim 19, wherein the neighboring modes include one mode closest to a specific mode in either clockwise or counter-clockwise direction.

21. The video encoder of claim 20, wherein the directional difference has one of −1, 0, and 1.

22. The video encoder of claim 18, wherein the means for encoding comprises:
a spatial transformer which performs spatial transform on the difference between the predicted block and the current block to create a transform coefficient;
a quantizer which quantizes the transform coefficient to produce a quantization coefficient; and
an entropy coding unit which losslessly encodes the quantization coefficient and the directional difference.

23. A multi-layered video decoder comprising:
means for performing lossless decoding on an input bitstream to extract a directional difference associated with an intra-prediction mode and texture data;
means for performing inverse quantization on the extracted texture data;
means for reconstructing residual blocks in a spatial domain from coefficients generated using the inverse quantization;
means for calculating an intra-prediction mode of a current residual block from an optimum intra-prediction mode of a lower layer block corresponding to the residual block and the directional difference associated with the intra-prediction mode; and
means for reconstructing a video frame from the residual block according to the calculated intra-prediction mode.

24. The video decoder of claim 23, wherein the means for calculating the intra-prediction mode adds the directional difference to the optimum prediction mode of the lower layer block in order to calculating the intra-prediction mode of the current residual block.

25. The video decoder of claim 24, wherein the means for reconstructing the video frame adds the reconstructed residual block to the previously reconstructed texture data of a neighboring block to the residual image according to the calculated intra-prediction mode.

26. The method of claim 23, wherein the directional difference is one of −1, 0, and 1.
